(19) United States
(12) Patent Application Publication
(10) Pub. No.: US 2024/0248508 A1
(43) Pub. Date: Jul. 25, 2024

(54) DIRECT DIGITAL SYNTHESIZER ALIGNMENT

(71) Applicant: Keysight Technologies, Inc., Santa Rosa, CA (US)

(72) Inventors: Michael S. Foster, Santa Rosa, CA (US); Matthew Todhunter, Santa Rosa, CA (US)

(21) Appl. No.: 18/101,334

(22) Filed: Jan. 25, 2023

(51) Int. Cl. G06F 1/02; H04L 7/04

(52) U.S. Cl. CPC G06F 1/022; H04L 7/04

(57) ABSTRACT

A direct digital synthesizer transmits a signal. The direct digital synthesizer includes a phase increment calculator, a phase accumulator, a phase-to-amplitude converter (PAC) and a phase preset calculator. The phase increment calculator determines a phase increment for a selected frequency. The phase accumulator accumulates the phase increment over time and provides an accumulated phase value. The phase-to-amplitude converter (PAC) converts the accumulated phase value to a periodic signal having the selected frequency. The phase preset calculator determines a phase preset value for the selected frequency of the periodic signal and a provided time offset for a time specified by a controlling event. The direct digital synthesizer is aligned with another direct digital synthesizer using the time offset based on measurements of a residual time alignment mismatch between the signal and another signal transmitted by the other direct digital synthesizer.

### BACKGROUND

A direct digital synthesizer includes a digital-to-analog converter and a numerically controlled oscillator. The numerically controlled oscillator includes a phase accumulator that accumulates phase and a phase-to-amplitude converter that converts accumulated phase into a sine wave to input to the digital-to-analog converter. Direct digital synthesizers are used to create a waveform from a single fixed frequency reference clock, so that the waveform occupies a frequency range lower than the fixed frequency reference clock. The fixed frequency reference clock drives the digital-to-analog converter to output the waveform as voltages over time. The fixed frequency may be in the radio frequency range, and the waveform may be used to synthesize a radio signal that is a lower frequency signal.

Efforts have been made to align phases between two direct digital synthesizers in a manner that is repeatable, but these efforts have relied on dense sampling of the response versus frequency to maintain alignment with frequency. Two direct digital synthesizers are aligned by establishing alignment between two known phase trajectories for the two direct digital synthesizers operating at the same frequency. To date, the efforts resulted in alignment of signals where the analog output from each direct digital synthesizer does not vary relative to the common center frequency. However, prior work resulted in some level of misalignment across the occupied bandwidth of the direct digital synthesizers as well as in the overlap region of two direct digital synthesizers operating with an offset to a common frequency.

To match the phase of each direct digital synthesizer across the occupied bandwidth prior work requires a direct digital synthesizer to be reset when modulation data is started. The alignment only works if all channels involved are reset at the same time, and the alignment loses coherence with any radio frequency channels not being reset at the same time. When performed, the result is a repeatable phase relationship that enables phase alignment via calibration at the reset. For this type of alignment, a different calibration is required for each different frequency. Modulated direct digital synthesizers that produce signals of some bandwidth do not currently maintain phase alignment of the overlapping signal across the signal bandwidth, regardless of whether the signals share a common center frequency.

### SUMMARY

According to an aspect of the present disclosure, a direct digital synthesizer transmits a signal. The direct digital synthesizer includes a phase increment calculator, a phase accumulator, a phase-to-amplitude converter (PAC) and a phase preset calculator. The phase increment calculator is configured to determine a phase increment for a selected frequency. The phase accumulator is configured to accumulate the phase increment over time and provide an accumulated phase value. The phase-to-amplitude converter (PAC) is configured to convert the accumulated phase value to a periodic signal having the selected frequency. The phase preset calculator is configured to determine a phase preset value for the selected frequency of the periodic signal and a provided time offset for a time specified by a controlling event. The direct digital synthesizer is aligned with another direct digital synthesizer using the time offset based on measurements of a residual time alignment mismatch between the signal and another signal transmitted by the other direct digital synthesizer.

According to another aspect of the present disclosure, a system includes a first direct digital synthesizer which transmits a first signal and a second direct digital synthesizer which transmits a second signal. The first direct digital synthesizer comprises a first phase increment calculator configured to determine a first phase increment for a selected frequency; a first phase accumulator configured to accumulate the first phase increment over time and provide a first accumulated phase value; a first phase-to-amplitude converter (PAC) configured to convert the first accumulated phase value to a first periodic signal having the selected frequency; and a first phase preset calculator configured to determine a first phase preset value for the selected frequency of the first periodic signal and a first provided time offset for a time specified by a controlling event. The second direct digital synthesizer comprises a second phase increment calculator configured to determine a second phase increment for the selected frequency; a second phase accumulator configured to accumulate the second phase increment over time and provide a second accumulated phase value; a second phase-to-amplitude converter (PAC) configured to convert the second accumulated phase value to a second periodic signal having the selected frequency; and a second phase preset calculator configured to determine a second phase preset value for the selected frequency of the second periodic signal and a second provided time offset for the time specified by the controlling event. The first direct digital synthesizer and the second direct digital synthesizer are aligned using the second time offset based on measurements of a first residual timing alignment mismatch between the first signal and the second signal.

According to another aspect of the present disclosure, a system includes a first direct digital synthesizer; a second direct digital synthesizer; and a controller comprising a memory that stores instructions and a processor that executes the instructions. The instructions when executed by the processor, cause the controller to: trigger the first direct digital synthesizer to transmit a first signal based on a trigger and trigger the second direct digital synthesizer to transmit a second signal based on the trigger; measure a residual timing alignment mismatch between the first signal and the second signal; set the first direct digital synthesizer to determine a first phase preset value for a selected frequency of a periodic signal and a first time offset for a time specified by a controlling event so that the first direct digital synthesizer is aligned with the second direct digital synthesizer using the first time offset based on measuring the residual time alignment mismatch between the first signal and the second signal; and set the second direct digital synthesizer to determine a second phase preset value for the selected frequency of the periodic signal and a second time offset for the time specified by the controlling event so that the second direct digital synthesizer is aligned with the first direct digital synthesizer using the second time offset based on measuring the residual time alignment mismatch between the first signal and the second signal.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates a direct digital synthesizer, in accordance with a representative embodiment.

FIG. 2 illustrates a first direct digital synthesizer and a second direct digital synthesizer in a system for direct digital synthesizer alignment, in accordance with a representative embodiment.

FIG. 3 illustrates a system for direct digital synthesizer alignment, in accordance with a representative embodiment.

FIG. 4 illustrates a system for direct digital synthesizer alignment, in accordance with a representative embodiment.

FIG. 5 illustrates a method for direct digital synthesizer alignment, in accordance with a representative embodiment.

FIG. 6A illustrates phase behavior for two direct digital synthesizers, in accordance with a representative embodiment.

FIG. 6B illustrates phase behavior for two direct digital synthesizers, in accordance with a representative embodiment.

FIG. 7A illustrates an effect of presetting phase timing for direct digital synthesizers, in accordance with a representative embodiment.

FIG. 7A illustrates an effect of presetting phase timing for direct digital synthesizers, in accordance with a representative embodiment.

FIG. 8 illustrates a computer system, on which a method for direct digital synthesizer alignment is implemented, in accordance with another representative embodiment.

### DETAILED DESCRIPTION

In the following detailed description, for the purposes of explanation and not limitation, representative embodiments disclosing specific details are set forth in order to provide a thorough understanding of embodiments according to the present teachings. However, other embodiments consistent with the present disclosure that depart from specific details disclosed herein remain within the scope of the appended claims. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. Definitions and explanations for terms herein are in addition to the technical and scientific meanings of the terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to”, or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below.

As described herein, direct digital synthesizers in multi-channel radio frequency systems may be made usable with one another across a bandwidth. Direct digital synthesizers may be aligned to account for residual timing alignment errors which exist after synchronization. Direct digital synthesizers may be provided a common frequency used for calculating phase preset values for each channel. Moreover, direct digital synthesizers may compensate for latency between a phase calculator and a modulator. The teachings herein provide an ability to align direct digital synthesizers across frequencies, while accounting for delays particular to the local oscillator(s) of each direct digital synthesizer operating at a different frequency.

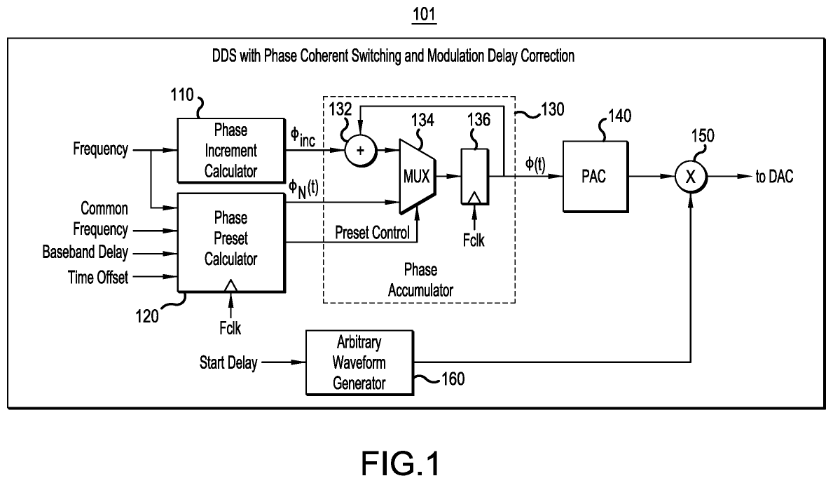

FIG. 1 illustrates a direct digital synthesizer, in accordance with a representative embodiment.

The direct digital synthesizer 101 in FIG. 1 includes a phase increment calculator 110, a phase preset calculator 120, a phase accumulator 130, a phase-to-amplitude converter 140 (PAC), a modulator 150, and an arbitrary waveform generator 160. The phase accumulator 130 includes an adder 132, a multiplexer 134 and a latch 136. The direct digital synthesizer 101 in FIG. 1 is provided with phase coherent switching and modulation delay correction using multi-channel phase coherent calculations.

The phase increment calculator 110 and the phase preset calculator 120 receive a selected frequency. The phase preset calculator 120 and the latch 136 of the phase accumulator 130 receive a system clock Folk. The system clock Folk may be provided by a host device (not shown), as an example. The selected frequency input to the phase increment calculator 110 and the phase preset calculator 120 may be input by a system user or a host device (not shown) to control operation of the direct digital synthesizer 101. The system clock Folk in FIG. 1 shows that the phase preset calculator 120 and the latch 136 in the phase accumulator 130 are controlled with the same clock and therefore have the same meaning of time.

The phase increment calculator 110 is configured to repeatedly determine a phase increment Φinc for the selected frequency. The phase increment calculator 110 provides the determined phase increment Φinc to the adder 132 of the phase accumulator 130.

The phase accumulator 130 is configured to accumulate the phase increment Φinc from the phase increment calculator 110 over time and provide an accumulated phase value Φ(t) as an output of latch 136 to the phase-to-amplitude converter 140 (PAC). The determined phase increment Φinc for the selected frequency from the phase increment calculator 110 is output to the adder 132 of the phase accumulator 130 from the phase increment calculator 110. Additionally, the accumulated phase value Φ(t) output from the latch 136 each clock period of a system clock Folk is fed back to the adder 132 and also provided to the phase-to-amplitude converter 140. The system clock Folk may be provided by a host device (not shown). The adder 132 is configured to add the determined phase increment Φinc for the selected frequency from the phase increment calculator 110 and the accumulated phase value Φ(t) output from the latch 136 at each clock period of the system clock Folk. The adder 132 is configured to add the phase increment Φinc to the previous accumulated phase value Φ(t) output from the latch 136.

The multiplexer 134 receives the added output from the adder 132 and the phase preset value ΦN(t) from phase preset calculator 120. The multiplexer 134 also receives a preset control signal from the phase preset calculator 120. The preset control signal from the phase preset calculator 120 switches the multiplexer 134 to selectively output either the added output from the adder 132 or the phase preset value ΦN(t) from the phase preset calculator 120. The preset control will control when the phase accumulator 130 is to be preset to the phase preset value ΦN(t) or will increment the stored value by the phase increment Φinc. The preset control signal will only select the phase preset value in response to a controlling event to the phase preset calculator 120.

The latch 136 is clocked at the same clock rate as the phase preset calculator 120 using the system clock Folk. The latch 136 latches the multiplexed output from the multiplexer 134 and provides the latched output of the accumulated phase value Φ(t) to the phase-to-amplitude converter 140 (PAC).

The phase-to-amplitude converter 140 (PAC) is configured to convert the accumulated phase value Φ(t) to a periodic signal having the selected frequency. The phase-to-amplitude converter 140 outputs the periodic signal to the modulator 150.

The phase preset calculator 120 receives the selected frequency which is also received by the phase increment calculator 110. The phase preset calculator 120 also receives a common frequency which is also provided to a phase preset calculator of another direct digital synthesizer. The phase preset calculator 120 also receives a baseband delay and a provided time offset. The phase preset calculator 120 is configured to determine a phase preset value for the selected frequency of the periodic signal and the provided time offset and the common frequency at the time specified by the controlling event.

The arbitrary waveform generator 160 generates an arbitrary waveform to be provided to the modulator 150. A waveform from the arbitrary waveform generator 160 and the signal transmitted by the direct digital synthesizer are synchronized to simultaneously reach the modulator 150 from a common controlling event.

The modulator 150 modulates the periodic signal having the selected frequency and the arbitrary waveform from the arbitrary waveform generator 160. The modulator 150 outputs a modulated signal to a digital-to-analog converter (DAC).

The direct digital synthesizer 101 in FIG. 1 includes multiple enhancements. For example, a residual timing alignment error that is present even after the direct digital synthesizer is synchronized with one or more other direct digital synthesizers is corrected so as to allow phase aligned baseband calculations regardless of frequency. The direct digital synthesizer 101 is aligned with another direct digital synthesizer using the time offset input to the phase preset calculator 120 based on measurements of a residual time alignment mismatch between the signal and another signal transmitted by the other direct digital synthesizer. To be sure, the time offset input to each phase preset calculator 120 may vary for each different direct digital synthesizer in a system, insofar as input time offsets are relative values to correct residual timing between the direct digital synthesizers. Phase calculations at the direct digital synthesizer and other direct digital synthesizers in a system are adjusted to compensate for delay mismatches, and specifically by adjusting the fundamental phase ramp, Fa, used in the calculations such that the phase calculations are corrected for all frequencies. This adjustment compensates for the delay errors seen at the operating frequency of the direct digital synthesizer 101 and the operating frequency of each other direct digital synthesizer.

Another enhancement involves providing the common frequency to all channels. Phase calculations by the phase preset calculator 120 may be performed with knowledge of a common frequency given to all channels. The phase preset value output from the phase preset calculator 120 is calculated based on the common frequency instead of the selected frequency input to the phase increment calculator 110 and the phase preset calculator 120. A phase offset between the channel of the direct digital synthesizer 101 relative to the common carrier frequency Fc is calculated, and any other direct digital synthesizer 101 may also similarly calculate an appropriate offset relative to the common carrier frequency Fc. Channels of different direct digital synthesizers can therefore be aligned using phase offsets particular to each direct digital synthesizer relative to the common carrier frequency Fc.

A further enhancement is provided to compensate for delays which affect latency between the phase preset calculator 120 and the modulator 150, using the start delay input to the arbitrary waveform generator 160 and the baseband delay provided to the phase preset calculator 120. The baseband delay provided to the phase preset calculator 120 may be set relative to a controlling event for the arbitrary waveform generator 160 so that a waveform from the arbitrary waveform generator and the signal transmitted by the direct digital synthesizer 101 are synchronized to simultaneously reach the modulator 150. A measured delay between the phase preset calculator 120 and the modulator 150 is compensated for so that the phase of the signal at the modulator 150 is identical to the signal of a direct digital synthesizer that was delayed so that a waveform from the arbitrary waveform generator 160 and the signal are synchronized to simultaneously reach the modulator 150 from a common controlling event.

Accordingly, the direct digital synthesizer 101 may be provided in a system that implements multiple radio frequency channels using direct digital synthesizers with wide-band modulation capability. Phases of signals output by the direct digital synthesizers in the system with direct digital synthesizer 101 may be aligned over a bandwidth and adjusted based on measurements specific to the direct digital synthesizer 101. The phases may be controlled not just for the center frequency or the numerically controlled oscillator frequency, but across the modulation bandwidth and between the multiple direct digital synthesizers. In a system that includes the direct digital synthesizer 101, phase coherence may be maintained and alignment across transitions of signals that overlap in frequency may account for digital baseband and radio frequency propagation delays in the calculation of phases for each direct digital synthesizer in the system. The teachings herein provide for arbitrary tuning of a multi-channel modulated radio frequency system while maintaining both phase coherency and phase alignment over frequencies. The result is that each local oscillator is made to act as if all the local oscillators are operating at a common frequency.

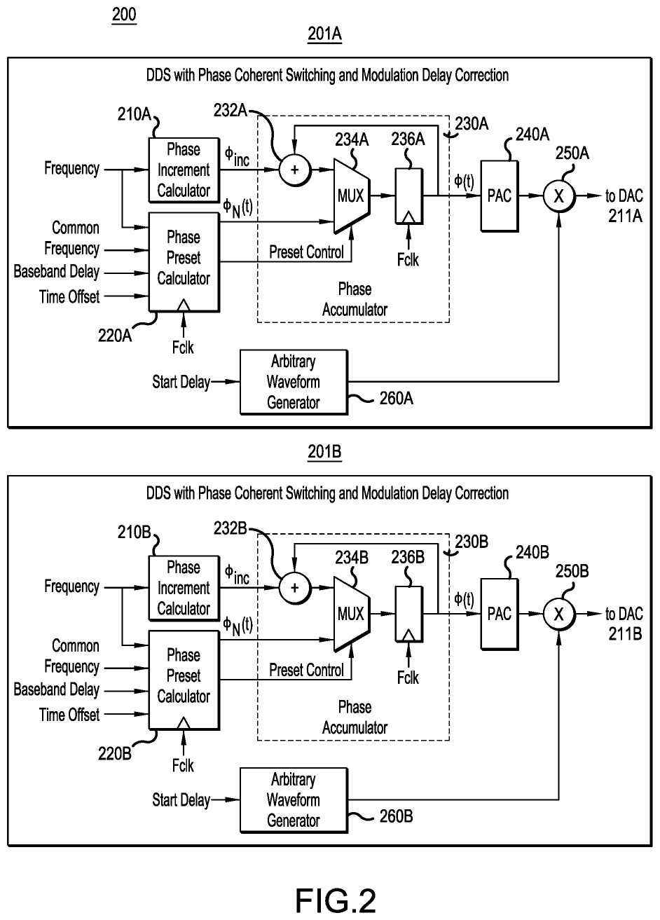

FIG. 2 illustrates a first direct digital synthesizer and a second direct digital synthesizer in a system for direct digital synthesizer alignment, in accordance with a representative embodiment.

The system 200 in FIG. 2 is a system for direct digital synthesizer alignment and includes components that may be provided separately and then integrated into the system 200.

The first direct digital synthesizer 201A includes a phase increment calculator 210A, a phase preset calculator 220A, a phase accumulator 230A, a phase-to-amplitude converter 240A (PAC), a modulator 250A, and an arbitrary waveform generator 260A. The phase increment calculator 210A receives a selected frequency and outputs a phase increment Φinc for the selected frequency. The phase preset calculator 220A also receives the selected frequency which is received by the phase increment calculator 210A. The phase preset calculator 220A also receives a common frequency which is also provided to the phase preset calculator 220B of the second direct digital synthesizer 201B. Phase calculations by the phase preset calculator 220A may be performed with knowledge of a common frequency given to all channels. The phase preset calculator 220A also receives a baseband delay and a time offset. The phase accumulator 230A includes an adder 232A, a multiplier 234A, and a latch 236A. The phase-to-amplitude converter 240A (PAC) is configured to convert the accumulated phase value Φ(t) from the phase accumulator 230A to a periodic signal having the selected frequency.

The second direct digital synthesizer 201B includes a phase increment calculator 210B, a phase preset calculator 220B, a phase accumulator 230B, a phase-to-amplitude converter 240B (PAC), a modulator 250B, and an arbitrary waveform generator 260B. The phase increment calculator 210B receives the selected frequency and outputs a phase increment Φinc for the selected frequency. The phase preset calculator 220B also receives the selected frequency which is received by the phase increment calculator 210B. The phase preset calculator 220B also receives the common frequency which is also provided to the phase preset calculator 220A of the first direct digital synthesizer 201A. Phase calculations by the phase preset calculator 220A and the phase preset calculator 220B may be performed with knowledge of the common frequency, and the common frequency may be provided to all channels. The phase preset calculator 220B also receives a baseband delay and a time offset. The phase accumulator 230B includes an adder 232B, a multiplier 234B, and a latch 236B. The phase-to-amplitude converter 240B (PAC) is configured to convert the accumulated phase value Φ(t) from the phase accumulator 230B to a periodic signal having the selected frequency.

The first direct digital synthesizer 201A may correspond to the direct digital synthesizer 101 in FIG. 1, and the second direct digital synthesizer 201B may also correspond to the direct digital synthesizer in FIG. 1. The first direct digital synthesizer 201A and the second direct digital synthesizer 201B are aligned in the system 200 in FIG. 2 based on time offsets provided to the phase preset calculator 220A and the phase preset calculator 220B. Additionally, each of the first direct digital synthesizer 201A and the second direct digital synthesizer 201B receives the common frequency at the phase preset calculator 220A and the phase preset calculator 220B. Moreover, each of the first direct digital synthesizer 201A and the second direct digital synthesizer 201B receives a baseband delay based on measurements particular to the first direct digital synthesizer 201A or the second direct digital synthesizer 201B, to compensate for latency between the phase preset calculators and modulators.

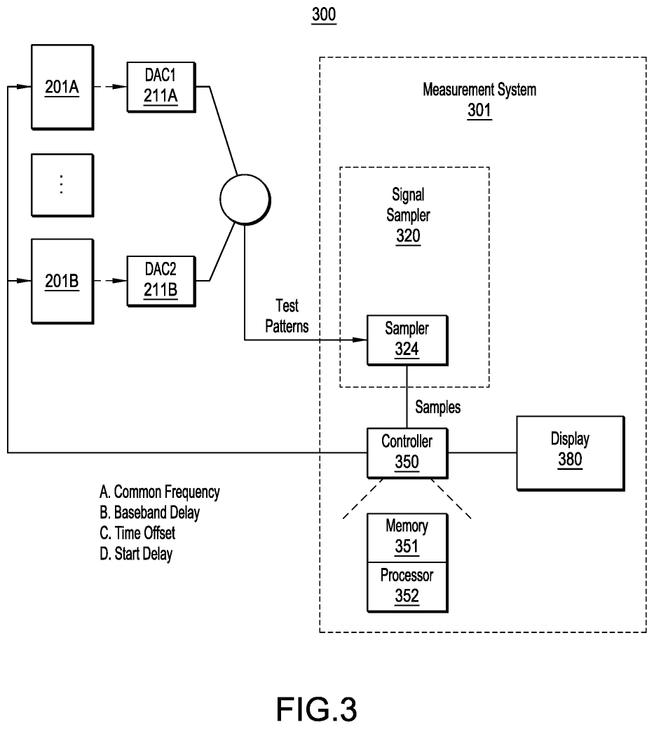

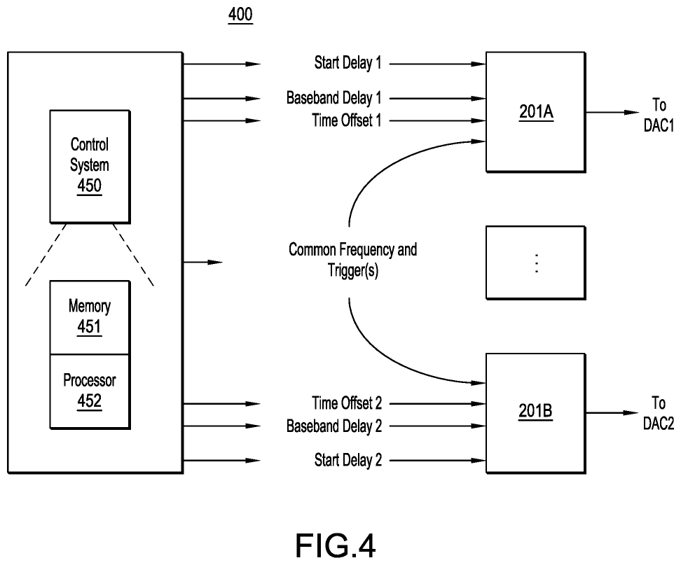

The first direct digital synthesizer 201A and the second direct digital synthesizer 201B may be aligned in operation so that a control system 450 shown in FIG. 4 provides the various inputs based on measurements taken by a measurement system 301 shown in FIG. 3. Additionally, for each of the first direct digital synthesizer 201A and the second direct digital synthesizer 201B, phase preset values may be calculated by the corresponding phase preset calculator for the selected frequency of the periodic signal and the provided time offset for a time specified by a controlling event. The phase preset value may also be determined with reference to the common frequency and the baseband delay provided to the corresponding phase preset calculator. A measured delay between the corresponding phase preset calculator and the corresponding modulator is compensated for so that a phase of the signal at the corresponding modulator is identical to a signal of a direct digital synthesizer that was delayed. As a result, the waveform from the corresponding arbitrary waveform generator and the signal are synchronized to simultaneously reach the corresponding modulator from a common controlling event.

As one example of changes compatible to the exemplary embodiments, FIG. 2 shows two direct digital synthesizers. However, more than two direct digital synthesizers may be provided in a system, such as in a system with three direct digital synthesizers. A third direct digital synthesizer may transmit a third signal and may comprise a third phase preset calculator, a third waveform generator and a third modulator. The third phase preset calculator may be configured to determine a third phase preset value for the selected frequency of the periodic signal and a third time offset for the time specified by the controlling event. The first direct digital synthesizer 201A and the second direct digital synthesizer 201B may be aligned across a bandwidth that includes the first signal and the second signal using the second time offset based on measurements of the first residual timing alignment mismatch between the first signal and the second signal, and the first direct digital synthesizer 201A and the third direct digital synthesizer may be aligned across a bandwidth that includes the first signal and the third signal using the third time offset based on measurements of a second residual timing alignment mismatch between the first signal and the third signal such that the third direct digital synthesizer is set to compensate the phase of the third signal using the third phase preset value for the selected frequency of the periodic signal and the third time offset.

FIG. 3 illustrates a system for direct digital synthesizer alignment, in accordance with a representative embodiment.

The system 300 in FIG. 3 is a system for direct digital synthesizer alignment and includes components that are provided separately except when used for measuring multiple direct digital synthesizers for alignment.

The system 300 in FIG. 3 includes the first direct digital synthesizer 201A and the second direct digital synthesizer 201B from FIG. 2, along with a first DAC 211A (digital-to-analog converter) and a second DAC 211B, and a measurement system 301. The measurement system 301 includes a signal sampler 320, a controller 350 and a display 380. The signal sampler 320 includes a sampler 324. The controller 350 includes a memory 351 that stores instructions and a processor 352 that executes the instructions.

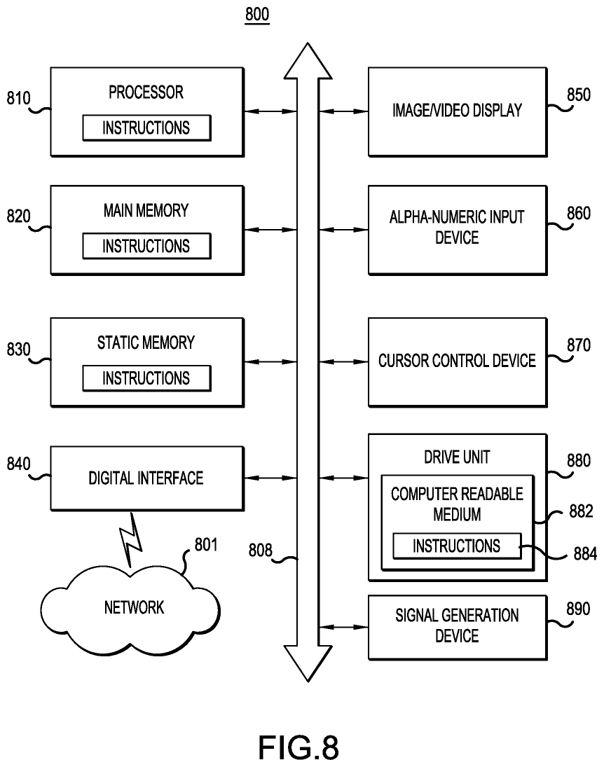

The controller 350 includes at least a memory 351 that stores instructions and a processor 352 that executes the instructions. A computer that can be used to implement the measurement system 301 as a whole or the controller 350 is depicted in FIG. 8, though a controller 350 may include fewer elements than depicted in FIG. 8. The controller 350 may also include interfaces including a first interface, a second interface, a third interface, and a fourth interface. One or more of the interfaces may include ports, disk drives, wireless antennas, or other types of receiver circuitry that connect the controller 350 to other electronic elements of the measurement system 301. One or more of the interfaces may also include user interfaces such as buttons, keys, a mouse, a microphone, a speaker, a display separate from the display 380, or other elements that users can use to interact with the controller 350 such as to enter instructions and receive output.

The controller 350 may perform some of the operations attributed to the measurement system 301 directly and may implement other operations described herein indirectly. For example, the controller 350 may indirectly control operations such as by generating and transmitting content to be displayed on the display 380. The controller 350 may directly control other operations such as logical operations performed by the processor 352 executing instructions from the memory 351 based on the instructions in the memory 351, the samples received from the sampler 324, and/or input received from electronic elements and/or users via the interfaces. Accordingly, the processes implemented by the controller 350 when the processor 352 executes instructions from the memory 351 may include steps not directly performed by the controller 350.

The display 380 may be local to the controller 350 and may be connected to the controller 350 via a local wired interface such as an Ethernet cable or via a local wireless interface such as a Wi-Fi connection. The display 380 may be interfaced with user input devices by which users can input instructions, including mouses, keyboards, thumbwheels and so on. The display 380 may be a monitor such as a computer monitor, a display on a mobile device, an augmented reality display, or another screen configured to display electronic imagery. The display 380 may also include one or more input interface(s) such as those noted above that may connect to other elements or components, as well as an interactive touch screen configured to display prompts to users and collect touch input from users.

The example instance of the measurement system 301 in FIG. 3 measures a residual timing alignment error between the first direct digital synthesizer 201A and the second direct digital synthesizer 201B, as well as between any other direct digital synthesizers in a system. The measured residual timing alignment error can then be corrected after synchronization between the first direct digital synthesizer 201A and the second direct digital synthesizer 201B.

The measurement system 301 is also used to measure test patterns from the first direct digital synthesizer 201A and the second direct digital synthesizer 201B. The controller 350 may apply a time offset for the first direct digital synthesizer 201A and the second direct digital synthesizer 201B during testing and acquire the phase relationship of the resultant signals in order to determine the start delay and phase offset for each direct digital synthesizer that results in precise phase alignment of the synthesizers.

The controller 350 may provide any one or more of a common frequency, frequency offset, phase offset, a time offset and a start delay to the first direct digital synthesizer 201A and the second direct digital synthesizer 201B during testing in order to determine a baseband delay between the phase preset calculators and the modulators in each of the first direct digital synthesizer 201A and the second direct digital synthesizer 201B. In use, the measured delay may be compensated for so that the phase of the signal at the modulator is identical to the signal of a direct digital synthesizer that was delayed so that a waveform from the waveform generator and the signal transmitted by the direct digital synthesizer are synchronized to simultaneously reach the modulator from a common controlling event regardless of tune frequency of either of the direct digital synthesizers.

FIG. 4 illustrates a system for direct digital synthesizer alignment, in accordance with a representative embodiment.

The system 400 in FIG. 4 is a system for direct digital synthesizer alignment and includes components that are provided together for aligning multiple direct digital synthesizers in use.

In FIG. 4, a system 400 includes a control system 450 and the first direct digital synthesizer 201A and the second direct digital synthesizer 201B.

The control system 450 may include a memory 451 that stores instructions and a processor 452 that executes the instructions. A computer that can be used to implement the control system 450 is depicted in FIG. 8, though a control system 450 may include fewer elements or different elements than depicted in FIG. 8. The control system 450 includes a memory 451 that stores instructions and a processor 452 that executes the instructions. The control system 450 provides the inputs to the first direct digital synthesizer 201A and the second direct digital synthesizer 201B, including a start delay, a baseband delay, a time offset, and the common frequency and triggers. The control system 450 may also include interfaces including a first interface, a second interface, a third interface, and a fourth interface. One or more of the interfaces may include ports, disk drives, wireless antennas, or other types of receiver circuitry that connect the control system 450 to the first direct digital synthesizer 201A and the second direct digital synthesizer 201B. One or more of the interfaces may also include user interfaces such as buttons, keys, a mouse, a microphone, a speaker, a display separate from the display 480, or other elements that users can use to interact with the control system 450 such as to enter instructions and receive output.

The control system 450 may perform some of the operations described herein directly and may implement other operations described herein indirectly. For example, the control system 450 may directly control operations such as logical operations performed by the processor 452 executing instructions from the memory 451 based on the instructions in the memory 451. However, the processes implemented by the control system 450 when the processor 452 executes instructions from the memory 451 may include steps not directly performed by the control system 450.

The control system 450 is configured to provide information that can be used to correct a residual timing alignment error after synchronization between the first direct digital synthesizer 201A and the second direct digital synthesizer 201B. The information provided by the control system 450 may include the common frequency, the baseband delay for each direct digital synthesizer, and the time offset for each direct digital synthesizer. Phase calculations by the phase preset calculator 220A and the phase preset calculator 220B may be performed with knowledge of a common frequency given to all channels.

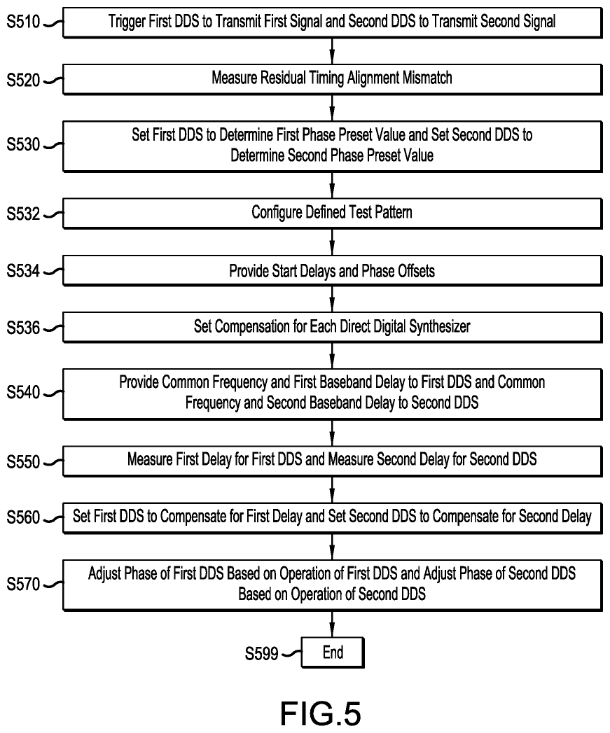

FIG. 5 illustrates a method for direct digital synthesizer alignment, in accordance with a representative embodiment.

The method of FIG. 5 starts at S510 with triggering a first direct digital synthesizer to transmit a first signal and a second direct digital synthesizer to transmit a second signal. The triggering at S510 may be simultaneous so as to identify timing discrepancies between the first direct digital synthesizer and the second direct digital synthesizer.

At S520, the method of FIG. 5 includes measuring a residual timing alignment mismatch based on the triggered first signal and the triggered second signal from S510. The residual timing alignment mismatch is an error that can be corrected in use after synchronization between the first direct digital synthesizer and the second direct digital synthesizer.

At S530, the method of FIG. 5 includes setting the first direct digital synthesizer to compensate a first phase preset value and setting the second direct digital synthesizer to compensate a second phase preset value.

At S532, includes configuring a defined test pattern on both direct digital synthesizers in order to measure and determine a start delay and phase offset for the first direct digital synthesizer and a start delay and phase offset for the second direct digital synthesizer. The configuring at S532 may be performed by the measurement system 301 of FIG. 3.

At S534, the method of FIG. 5 includes measuring a start delay and phase offset to be provided to the first direct digital synthesizer and a start delay and phase offset to be provided to the second direct digital synthesizer. The start delays and phase offsets measured at S534 may be performed by the measurement system 301 of FIG. 3.

At S536, the first direct digital synthesizer is set to compensate for the first delay and phase offset and the second direct digital synthesizer is set to compensate for the second delay and phase offset. Compensation may be provided as a first time offset and a second time offset for different direct digital synthesizers. However, compensation may also be set to zero for one direct digital synthesizer and an offset value corresponding to a calculated offset for another direct digital synthesizer. The first direct digital synthesizer and the second direct digital synthesizer may be set at S536 by the measurement system 301 in FIG. 3.

At S540, a common frequency and a first baseband delay is provided to a first direct digital synthesizer and the common frequency and a second baseband delay is provided to a second direct digital synthesizer. Phase calculations by the phase preset calculator of the first direct digital synthesizer and the second direct digital synthesizer may be performed with knowledge of a common frequency given to all channels. The common frequency and the baseband delays provided at S540 may be provided by the measurement system 301 of FIG. 3.

At S550, the method of FIG. 5 includes configuring a defined test pattern for both synthesizers with a separation in synthesizer frequency. The baseband delay required for precise phase alignment may be measured and determined using the defined test pattern. S550 may be performed by the measurement system 301 of FIG. 3.

At S560, the first direct digital synthesizer is set to compensate for the first baseband delay and the second direct digital synthesizer is set to compensate for the second base band delay. S560 may be performed by the measurement system 301 of FIG. 3.

At S570, a phase of the first direct digital synthesizer is adjusted based on an operation of the first direct digital synthesizer, and a phase of the second direct digital synthesizer is adjusted based on an operation of the second direct digital synthesizer. System level calibration for a system that includes the first direct digital synthesizer and the second direct digital synthesizer may be provided to result in a stable and coherent phase across transitions for each channel as well as phase aligned baseband calculations regardless of synthesizer frequency in the presence of residual timing alignment error that is relevant in multi-channel systems. Delay mismatches between the first direct digital synthesizer and the second direct digital synthesizer may be compensated by adjusting the phase calculations, and specifically by adjusting the fundamental phase ramp, Fa, used in the calculations such that the phase calculations are corrected for all frequencies. This adjustment will compensate for the delay errors seen at the operating frequency of the first direct digital synthesizer and the operating frequency of the second direct digital synthesizer. S570 may be performed using the control system 450 of FIG. 4.

When the method of FIG. 5 is finished, the method of FIG. 5 ends at S599.

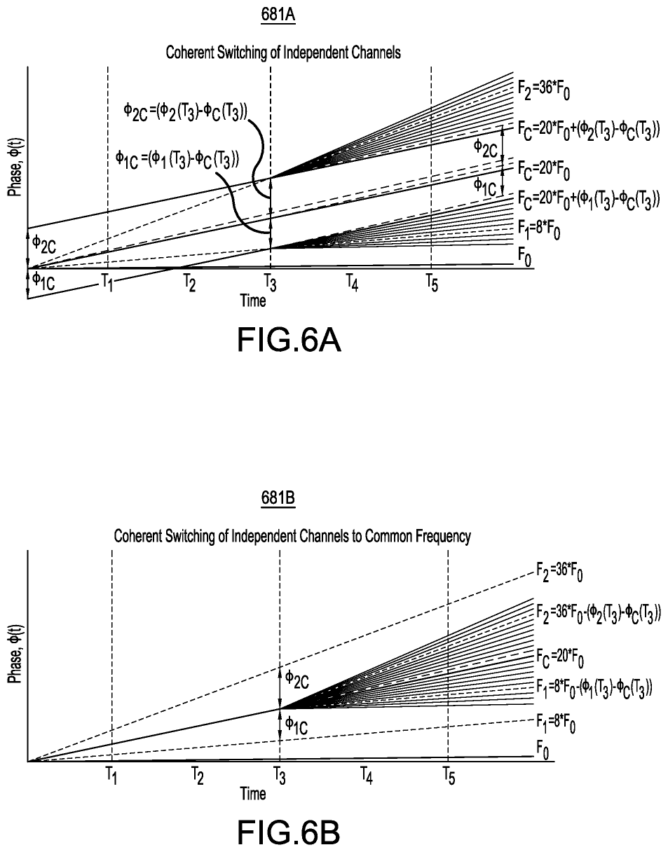

FIG. 6A illustrates phase behavior for two direct digital synthesizers, in accordance with a representative embodiment.

In FIG. 6A, the phase behavior shown is of two independent channels running at different frequencies. The first channel operates at frequency F1 and the second channel operates at frequency F2. Both channels have frequency content at common frequency Fc. Though the radio frequency content overlaps in frequency, there will be a phase offset between the two channels based on the difference between the common frequency Fc and the operating frequency of the channel.

FIG. 6B illustrates phase behavior for two direct digital synthesizers, in accordance with a representative embodiment.

As shown in FIG. 6B, the phase offset of each channel from FIG. 6A relative to the phase of a common frequency, Fc, can be calculated. By applying the correct phase value, two radio frequency channels can be offset to be aligned at the common frequency, Fc. The common carrier frequency Fc is not required to be within the frequency band of either channel, but it is easier to illustrate the behavior when the common frequency, Fc, is in the overlapping frequency range of the two channels. The phase delta does not actually need to be known when calculating the phase preset value, as only the absolute phase preset value needs to be calculated for the common frequency instead of the direct digital synthesizer frequency. After applying the correct offsets, the common frequency components in each channel will be aligned properly as shown in FIG. 6B. Phase calculations by the phase preset calculator of each direct digital synthesizer in a system such as the system 200 may be performed with knowledge of a common frequency given to all channels.

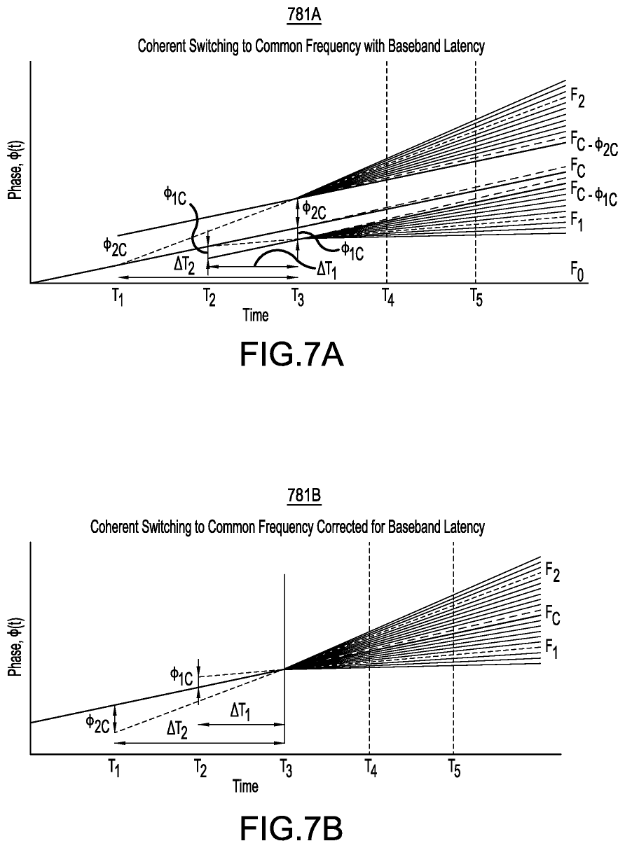

FIG. 7A illustrates an effect of presetting phase timing for direct digital synthesizers, in accordance with a representative embodiment.

Another enhancement provided by the present teachings involves calculating a phase preset that will compensate for latency between the phase calculations by the phase increment calculator and when the baseband data arrives. The phase preset value is calculated by the phase preset calculator for the selected frequency of the periodic signal and a provided time offset for a time specified by a controlling event. The selected frequency, the common frequency, the baseband delay, and the time offset are all provided to the phase preset calculator, as shown for the phase preset calculator 120 in FIG. 1. In a system in use, the baseband modulation will usually be misaligned at the modulator to compensate for variations in the radio frequency path delay of each channel that occur after the modulator. When a channel performs the phase calculations and then applies the phase calculations, an offset in phase is related to the time delta between performing the calculations and applying them. FIG. 7A illustrates how presetting the phase at a different time will generate a phase offset error when the baseband modulation is applied.

Both channels have baseband data applied at time T3. Chanel 1 calculations are applied at time T2, and Channel 2 calculations are applied at T1. The phase offset is the difference in the phase slope over the time between the calculations and the start of the baseband modulation. Specifically for Channel 2, the phase offset is calculated from the difference between the phase of F2 and the phase of Fc over the time ΔT2.

FIG. 7A illustrates an effect of presetting phase timing for direct digital synthesizers, in accordance with a representative embodiment.

The phase offset for Channel 2 is Φ2C, and is calculated as the product of the ΔT2 shown in FIG. 2 and the difference between the common frequency FC and the second frequency F2, or Φ2C=ΔT2(FC−F2). Once the offset is applied the two channels are aligned.

By combining the three enhancements described herein, the direct digital synthesizer phase calculations result in phase aligned channels for ideally matched radio frequency channels under all output frequency conditions. With non-ideal radio frequency hardware, the three enhancements enable straightforward compensation. Using the three enhancements make each local oscillator act as if all the local oscillators are operating at a common frequency, keeping the phase relationship of the channels aligned without losing coherence with other, undisturbed, channels.

FIG. 8 illustrates a computer system, on which a method for direct digital synthesizer alignment is implemented, in accordance with another representative embodiment.

Referring to FIG. 8, the computer system 800 includes a set of software instructions that can be executed to cause the computer system 800 to perform any of the methods or computer-based functions disclosed herein. The computer system 800 may operate as a standalone device or may be connected, for example, using a network 801, to other computer systems or peripheral devices. In embodiments, a computer system 800 performs logical processing based on digital signals received via an analog-to-digital converter.

The computer system 800 can be implemented as or incorporated into various devices, such as a workstation that includes a controller or control system, a stationary computer, a mobile computer, a personal computer (PC), a laptop computer, a tablet computer, or any other machine capable of executing a set of software instructions (sequential or otherwise) that specify actions to be taken by that machine. The computer system 800 can be incorporated as or in a device that in turn is in an integrated system that includes additional devices. Further, while the computer system 800 is illustrated in the singular, the term “system” shall also be taken to include any collection of systems or sub-systems that individually or jointly execute a set, or multiple sets, of software instructions to perform one or more computer functions.

As illustrated in FIG. 8, the computer system 800 includes a processor 810. The processor 810 may be considered a representative example of a processor of a controller and executes instructions to implement some or all aspects of methods and processes described herein. The processor 810 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 810 is an article of manufacture and/or a machine component. The processor 810 is configured to execute software instructions to perform functions as described in the various embodiments herein. The processor 810 may be a general-purpose processor or may be part of an application specific integrated circuit (ASIC). The processor 810 may also be a microprocessor, a microcomputer, a processor chip, a controller, a microcontroller, a digital signal processor (DSP), a state machine, or a programmable logic device. The processor 810 may also be a logical circuit, including a programmable gate array (PGA), such as a field programmable gate array (FPGA), or another type of circuit that includes discrete gate and/or transistor logic. The processor 810 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 800 further includes a main memory 820 and a static memory 830, where memories in the computer system 800 communicate with each other and the processor 810 via a bus 808. Either or both of the main memory 820 and the static memory 830 may be considered representative examples of a memory of a controller, and store instructions used to implement some or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 820 and the static memory 830 are articles of manufacture and/or machine components. The main memory 820 and the static memory 830 are computer-readable mediums from which data and executable software instructions can be read by a computer (e.g., the processor 810). Each of the main memory 820 and the static memory 830 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 800 further includes a video display unit 850, such as a liquid crystal display (LCD), an organic light emitting diode (OLED), a flat panel display, a solid-state display, or a cathode ray tube (CRT), for example. Additionally, the computer system 800 includes an input device 860, such as a keyboard/virtual keyboard or touch-sensitive input screen or speech input with speech recognition, and a cursor control device 870, such as a mouse or touch-sensitive input screen or pad. The computer system 800 also optionally includes a disk drive unit 880, a signal generation device 890, such as a speaker or remote control, and/or a network interface device 840.

In an embodiment, as depicted in FIG. 8, the disk drive unit 880 includes a computer-readable medium 882 in which one or more sets of software instructions 884 (software) are embedded. The sets of software instructions 884 are read from the computer-readable medium 882 to be executed by the processor 810. Further, the software instructions 884, when executed by the processor 810, perform one or more steps of the methods and processes as described herein. In an embodiment, the software instructions 884 reside all or in part within the main memory 820, the static memory 830 and/or the processor 810 during execution by the computer system 800. Further, the computer-readable medium 882 may include software instructions 884 or receive and execute software instructions 884 responsive to a propagated signal. The software instructions 884 may be transmitted or received over the network 801 via the network interface device 840.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

Accordingly, direct digital synthesizer alignment enables arbitrary tuning of a multi-channel modulated radio frequency system while maintaining both phase coherence and alignment with direct digital synthesizer frequency. The teachings set forth above result in aligned phase versus frequency and compensation for delay from each local oscillator operating at a different frequency. Each local oscillator may be made to function as if all local oscillators in the multi-channel modulated radio frequency system are operating at a common frequency. The phase relationship of the channels is made repeatable without losing coherence with other channels not being disturbed. The teachings herein also allow for the application of calibration to be dependent on only the local frequency range of the channel instead of requiring information about other channels.

Although direct digital synthesizer alignment has been described with reference to several exemplary embodiments, it is understood that the words that have been used are words of description and illustration, rather than words of limitation. Changes may be made within the purview of the appended claims, as presently stated and as amended, without departing from the scope and spirit of direct digital synthesizer alignment in its aspects. Although direct digital synthesizer alignment has been described with reference to particular means, materials and embodiments, direct digital synthesizer alignment is not intended to be limited to the particulars disclosed; rather direct digital synthesizer alignment extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A direct digital synthesizer which transmits a signal, comprising:
a phase increment calculator configured to determine a phase increment for a selected frequency;
a phase accumulator configured to accumulate the phase increment over time and provide an accumulated phase value;
a phase-to-amplitude converter (PAC) configured to convert the accumulated phase value to a periodic signal having the selected frequency; and
a phase preset calculator configured to determine a phase preset value for the selected frequency of the periodic signal and a provided time offset for a time specified by a controlling event, wherein the direct digital synthesizer is aligned with another direct digital synthesizer using the time offset based on measurements of a residual time alignment mismatch between the signal and another signal transmitted by the other direct digital synthesizer.

2. The direct digital synthesizer of claim 1,
wherein the phase preset calculator is also provided with a common frequency and determines the phase preset value for the signal with reference to the common frequency.

3. The direct digital synthesizer of claim 2, wherein the phase preset calculator also receives a baseband delay and determines the phase preset value with reference to the baseband delay.

4. The direct digital synthesizer of claim 3, further comprising:
a waveform generator; and
a modulator, wherein a measured delay between the phase preset calculator and the modulator is compensated for so that a phase of the signal at the modulator is identical to the signal of a direct digital synthesizer that was delayed so that a waveform from the waveform generator and the signal are synchronized to simultaneously reach the modulator from a common controlling event.

5. A system, comprising:
a first direct digital synthesizer which transmits a first signal and comprising a first phase increment calculator configured to determine a first phase increment for a selected frequency; a first phase accumulator configured to accumulate the first phase increment over time and provide a first accumulated phase value; a first phase-to-amplitude converter (PAC) configured to convert the first accumulated phase value to a first periodic signal having the selected frequency; and a first phase preset calculator configured to determine a first phase preset value for the selected frequency of the first periodic signal and a first provided time offset for a time specified by a controlling event; and
a second direct digital synthesizer which transmits a second signal and comprising a second phase increment calculator configured to determine a second phase increment for the selected frequency; a second phase accumulator configured to accumulate the second phase increment over time and provide a second accumulated phase value; a second phase-to-amplitude converter (PAC) configured to convert the second accumulated phase value to a second periodic signal having the selected frequency; and a second phase preset calculator configured to determine a second phase preset value for the selected frequency of the second periodic signal and a second provided time offset for the time specified by the controlling event, wherein the first direct digital synthesizer and the second direct digital synthesizer are aligned using the second provided time offset based on measurements of a first residual timing alignment mismatch between the first signal and the second signal.

6. The system of claim 5,
wherein the first phase preset calculator is provided with a common frequency and determines the first phase preset value for the first signal with reference to the common frequency; and
wherein the second phase preset calculator is provided with the common frequency and determines the second phase preset value for the second signal with reference to the common frequency.

7. The system of claim 6,
wherein the first phase preset calculator also receives a first baseband delay and determines the first phase preset value with reference to the first baseband delay, and
wherein the second phase preset calculator receives a second baseband delay and determines the second phase preset value with reference to the second baseband delay.

8. The system of claim 7,
wherein the first direct digital synthesizer further comprises a first waveform generator and a first modulator, wherein a measured first delay between the first phase preset calculator and the first modulator is compensated for so that a phase of the first signal at the first modulator is identical to a signal of a direct digital synthesizer that was delayed so that a waveform from the first waveform generator and the first signal are synchronized to simultaneously reach the first modulator from a common controlling event, and
wherein the second direct digital synthesizer further comprises a second waveform generator and a second modulator, wherein a measured second delay between the second phase preset calculator and the second modulator is compensated for so that the phase of the signal at the second modulator is identical to the signal of a direct digital synthesizer that was delayed so that a waveform from the second waveform generator and the second signal are synchronized to simultaneously reach the second modulator from a common controlling event.

9. The system of claim 8, wherein a phase of the first signal is adjusted based on an operation of only the first direct digital synthesizer; and
wherein a phase of the second signal is adjusted based on an operation of only the second direct digital synthesizer.

10. The system of claim 8, wherein the first direct digital synthesizer and the second direct digital synthesizer are aligned across a bandwidth that includes the first signal and the second signal based on setting the second direct digital synthesizer to compensate the phase of the second signal using the second phase preset value for selected frequency of the second periodic signal and second provided time offset.

11. The system of claim 8, further comprising:
a third direct digital synthesizer which comprises third phase preset calculator, a third waveform generator and a third modulator and which transmits a third signal,
wherein the third phase preset calculator is configured to determine a third phase preset value for the selected frequency of a third periodic signal and a third provided time offset for the time specified by the controlling event, wherein the first direct digital synthesizer and the second direct digital synthesizer are aligned across a bandwidth that includes the first signal and the second signal using the second provided time offset based on measurements of the first residual timing alignment mismatch between the first signal and the second signal, and
wherein the first direct digital synthesizer and the third direct digital synthesizer are aligned across a bandwidth that includes the first signal and the third signal using the third provided time offset based on measurements of a second residual timing alignment mismatch between the first signal and the third signal such that the third direct digital synthesizer is set to compensate the phase of the third signal using the third phase preset value for the selected frequency of the third periodic signal and the third provided time offset.

12. The system of claim 8, wherein the first direct digital synthesizer comprises a first phase increment calculator configured to determine a phase increment for the selected frequency of the first periodic signal, a first phase accumulator configured to accumulate the phase increment over time and provide an accumulated phase value, a first phase-to-amplitude converter configured to convert the accumulated phase value to a periodic signal having the selected frequency of the first periodic signal, and a first phase preset calculator configured to receive a common frequency and determine a first phase preset value for the first signal in reference to the common frequency; and
wherein the second direct digital synthesizer comprises a second phase increment calculator configured to determine a phase increment for the selected frequency of the second periodic signal, a second phase accumulator configured to accumulate the phase increment over time and provide an accumulated phase value, a second phase-to-amplitude converter configured to convert the accumulated phase value to a periodic signal having the selected frequency of the second periodic signal, and a second phase preset calculator configured to receive the common frequency and determine a second phase preset value for the second signal in reference to the common frequency.

13. A system, comprising:
a first direct digital synthesizer;
a second direct digital synthesizer; and
a controller comprising a memory that stores instructions and a processor that executes the instructions, wherein the instructions when executed by the processor, cause the controller to:
trigger the first direct digital synthesizer to transmit a first signal based on a trigger and trigger the second direct digital synthesizer to transmit a second signal based on the trigger;
measure a residual timing alignment mismatch between the first signal and the second signal;
set the first direct digital synthesizer to determine a first phase preset value for a selected frequency of a periodic signal and a first time offset for a time specified by a controlling event so that the first direct digital synthesizer is aligned with the second direct digital synthesizer using the first time offset based on measuring the residual time alignment mismatch between the first signal and the second signal; and
set the second direct digital synthesizer to determine a second phase preset value for the selected frequency of the periodic signal and a second time offset for the time specified by the controlling event so that the second direct digital synthesizer is aligned with the first direct digital synthesizer using the second time offset based on measuring the residual time alignment mismatch between the first signal and the second signal.

14. The system of claim 13, wherein the instructions when executed by the processor further cause the controller to:
provide a common frequency to a first phase preset calculator of the first direct digital synthesizer and to a second phase preset calculator of the second direct digital synthesizer such that the first direct digital synthesizer determines the first phase preset value for the first signal with reference to the common frequency and such that the second direct digital synthesizer determines the second phase preset value for the second signal with reference to the common frequency.

15. The system of claim 14, wherein the instructions when executed by the processor further cause the controller to:
provide a first baseband delay to the first phase preset calculator of the first direct digital synthesizer to determine the first phase preset value for the first signal with reference to the common frequency; and
provide a second baseband delay to the second phase preset calculator of the second direct digital synthesizer to determine the second phase preset value for the second signal with reference to the common frequency.

16. The system of claim 14, wherein the instructions when executed by the processor further cause the controller to:
measure a first delay between the first phase preset calculator and a first modulator of the first direct digital synthesizer;
compensate for the first delay between the first phase preset calculator and the first modulator;
measure a second delay between the second phase preset calculator and a second modulator of the second direct digital synthesizer; and
compensate for the second delay between the second phase preset calculator and the second modulator.

17. The system of claim 16, wherein the instructions when executed by the processor further cause the controller to:
when compensating for the first delay, set the first time offset relative to a trigger for a first waveform generator of the first direct digital synthesizer so that a first waveform from the first waveform generator and the first signal are synchronized to simultaneously reach a first modulator of the first direct digital synthesizer; and
when compensating for the second delay, set the second time offset relative to a trigger for a second waveform generator of the second direct digital synthesizer so that a second waveform from the second waveform generator and the second signal are synchronized to simultaneously reach a second modulator of the second direct digital synthesizer.

18. The system of claim 17, wherein the instructions when executed by the processor further cause the controller to:
adjust a phase of the first direct digital synthesizer based on an operation of the first direct digital synthesizer; and
adjust a phase of the second direct digital synthesizer based on an operation of the second direct digital synthesizer.

19. The system of claim 13, wherein the instructions when executed by the processor further cause the controller to:
align the first direct digital synthesizer and the second direct digital synthesizer across a bandwidth that includes the first signal and the second signal using the second time offset based on measuring the residual timing alignment mismatch between the first signal and the second signal such that the second direct digital synthesizer is set to compensate a phase of the second signal using the second phase preset value for the selected frequency of the periodic signal and the second time offset.
